(19) United States
(12) Patent Application Publication
(10) Pub. No.: US 2015/0029410 A1
(43) Pub. Date: Jan. 29, 2015

(54) HEAD UP DISPLAY LENS

(71) Applicant: BAE SYSTEMS plc, London (GB)

(72) Inventors: Leslie Charles Laycock, Chelmsford (GB); Christopher Stace, Bristol (GB); Ferhat Culfaz, Bristol (GB)

(73) Assignee: BAE SYSTEMS plc, London (GB)

(21) Appl. No.: 14/373,128

(22) PCT Filed: Jan. 9, 2013
(86) PCT No.: PCT/GB2013/050028

§ 371 Date: Jul. 18, 2014

(30) Foreign Application Priority Data
Jan. 20, 2012 (GB) 1200929.6

(51) Int. Cl. G02B 27/01; G02F 1/1335; G02B 1/11

(52) U.S. Cl. CPC G02B 27/0101; G02B 1/11; G02F 1/133621; G02B 2027/0112; G02B 2027/013; G02B 2027/0141
USPC 349/11; 359/631

(57) ABSTRACT

The following invention relates to an improved lens apparatus for use in a head up display (HUD), particularly for providing HUD with a depth of field and more particularly with providing a secondary virtual image in a different colour so as to provide a warning message.

The partially reflecting combiner has a first surface S₁ located closest to a display, and a second surface S₂, located furthest from the display, wherein the effective radius of curvature of surface S₂>S₁, so as to provide two non-coincident virtual images.

The selection of antireflective coatings on the surfaces S₂ and S₁ allows the non-coincident virtual images to have different coloured virtual images.

The following invention relates to an improved lens apparatus for use in a head up display (HUD), particularly for providing HUD with a depth of field and more particularly with providing a secondary virtual image in a contrasting or different colour so as to provide a warning message.

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

According to a first aspect of the invention there is provided a display device for vehicles comprising,

a display which provides system information that is to be displayed to a user,
a partially reflecting combiner, which magnifies the system information from the display, and provides a virtual image of said display,
wherein said partially reflecting combiner has a first curved surface S₁ located closest to the display, and a second curved surface S₂, located furthest from the display, wherein the radii of curvature of surface S₂>S₁, so as to provide two non-coincident virtual images.

The use of a partially reflective combiner removes the requirement of projecting the image directly onto a windscreen, which latter method typically requires specific alignment of the display to ensure that the virtual images appear in the eye line of the user.

The lens surface S₁ and S₂ preferably have a curvature that is a smooth arcuate curve, such as a part of a circle or an ellipse. The radii R₁ and R₂ and hence of curvature of surface S₂>S₁, so as to provide two non-coincident virtual images. Preferably the partially reflecting combiner is a negative meniscus lens.

The user is a person or more specifically the eye-line or line of sight of the person.

The combiner may have a thickness (ΔU) in the range of from 2 mm to 6 mm, preferably in the range of from 3 mm to 5 mm. The combiner may be selected from any material which has a high optical transmission in the visible region, typically 400-800 nm, such as, for example glass, polycarbonate or PMMA (polymethyl methacrylate), preferably the refractive index (n) is in the range of from 1.30 to 1.80, more preferably 1.45 to 1.65.

The surfaces may include one or more of a texture, coating, dye, light emitting layer, matte finish, diffuse finish, specular finish, and optically smooth finish.

The display may be located at a distance (U), in the range of from 100 mm to 500 mm, from the combiner, more preferably (U) is in the range of from 150 to 300 mm.

The virtual image may be preferably projected at a distance (V) in the range of from 500 mm to 2000 mm, such that the virtual image appears outside the vehicle, more preferably V is in the range of from 900 mm to 1500 mm.

The magnification (M) of the lens is in the range of from 3 to 10, more preferably in the range of 3 to 7. If the magnification is too high the virtual image may be distorted.

The imaging formula for a concave mirror is

$$\frac{1}{{f}_{1 , 2}} = \frac{1}{{U}_{1 , 2}} - \frac{1}{{V}_{1 , 2}} \qquad ( 1 )$$

Where f1,2 is the focal length of the mirror's reflective surface, substituting for f_{1,2} gives:

$$\frac{2}{{R}_{1 , 2}} = \frac{1}{{U}_{1 , 2}} - \frac{1}{{V}_{1 , 2}}$$

### For Surface S₂

$$\frac{1}{{V}_{2}} = \frac{1}{( {U}_{1} + Δ U )} - \frac{2}{{R}_{2}} \\ ∴ {V}_{2} = \frac{{R}_{2} ( {U}_{1} + Δ U )}{[ {R}_{2} - 2 ( {U}_{1} + Δ U ) ]}$$

Therefore virtual image separation ΔV, V₁−V₂, is given by:

$${V}_{1} - {V}_{2} = Δ V = \frac{{R}_{1} {U}_{1}}{( {R}_{1} - 2 {U}_{1} )} - \frac{{R}_{2} ( {U}_{1} + Δ U )}{[ {R}_{2} - 2 ( {U}_{1} + Δ U ) ]}$$

### From Eqn (1):

$$\begin{matrix}\frac{2}{{R}_{2}} = \frac{1}{U + Δ U} - \frac{1}{V - Δ V} \\ = \frac{V - Δ V - U - Δ U}{( U + Δ U ) ( V - Δ V )} \\ = \frac{U ( M - 1 ) - ( Δ V + Δ U )}{( U + Δ U ) ( MU - Δ V )}\end{matrix} \\ ∴ {R}_{2} = \frac{2 ( U + Δ U ) ( MU - Δ V )}{U ( M - 1 ) - ( Δ V + Δ U )}$$

When the volume between S₁ and S₂ is filled with a material of refractive index n, a negative meniscus lens is formed which tends to increase the effective radius of curvature of surface S₂. By ray tracing, the value, R′₂, centre of curvature, C′₂, is given by:

$${R}_{2}^{′} = {R}_{2} - ( \frac{n - 1}{ n} ) ( {R}_{2} - {R}_{1} )$$

In a preferred arrangement the radius of curvature, R₂, of surface S₂ may be adjusted to generate a secondary virtual image that appears in front of the primary virtual image generated by surface S₁. Preferably, wherein the volume between S₁ and S₂ is filled with a material of refractive index n, the effective curvature of R′₂ is given by

$${R}_{2}^{′} = {R}_{2} - ( \frac{n - 1}{ n} ) ( {R}_{2} - {R}_{1} )$$

R₁ may be selected in the region of from 330 mm to 900 mm, more preferably 400 mm to 600 mm, giving rise to corresponding radii R₂ in the range of from 340 mm to 980 mm, and more preferably 410 mm to 710 mm.

The surface S₁ of the combiner provides the first primary virtual image, and surface S₂, provides the secondary virtual image. The manipulation of the radii of curvature may be used to enhance the secondary virtual image. If the secondary virtual image generated by the secondary reflection is such that it appears in close proximity to the primary virtual image generated by the first surface S₁, then the virtual image will appear to have a 3-D effect. For example, if the speed of the vehicle is being displayed, the numerals will appear to have depth, resulting in a more substantial appearance.

In one arrangement the separation between the two virtual images ΔV, may have a separation which provides a 3D perspective, such that the ΔV may be selected in the region of 1 mm to 20 mm, more preferably 3 mm to 10 mm. Where ΔV is small, then the difference of the radii R₂ and of lens surfaces S₂ and S₁ will be small, such as, for example 410 mm and 400 mm respectively.

In a preferred arrangement the separation between the two virtual images ΔV, provides a warning secondary virtual image, where ΔV may be selected in the region of 30 mm to 800 mm, more preferably 100 mm to 700, yet more preferably 200 mm to 600 mm This provides a primary virtual image and a warning secondary virtual image, wherein the latter is significantly closer to the user, and hence may serve to provide system information which is of greater importance, such as, for example, a warning message, failure of a component, hazard detection etc.

When the separation between the two virtual images ΔV is selected such that it provides a warning secondary virtual image, it may be difficult to visually distinguish from the primary virtual image. It may be desirable to provide the warning secondary virtual image in a colour which visually contrasts with the primary virtual image.

In a highly preferred arrangement at least one anti-reflection coating is applied to at least one of surfaces S₁ or S₂.

There may be at least one anti reflection coating on surface S₁ and at least one anti reflection coating on surface S₂. In a highly preferred arrangement, the anti-reflection coating on S₁ and S₂ are selected, such that S₁ is spectrally matched to the display's spectral output, to provide high reflectivity at specific wavelengths and also possesses a reflectance minima in a first narrow wave band. The antireflective coating on surface S₂ is selected to have a reflectance maxima in substantially the same first narrow wave band, and a reflectance minima across the remainder of the visible wavebands, such that said secondary virtual image projected from surface S₂ is presented in the colour as defined by the first narrow waveband, and is additionally presented in front of the primary virtual image from the surface S₁.

By way of an example only, the coatings on S₁ and S₂ may be selected such that the first narrow wave band is selected such that the second surface only permits a red colour to be displayed as a coloured warning secondary virtual image, thus providing a warning or danger information in front of the primary virtual image from surface S₁.

The anti reflective coating may be selected from any spectrally active coating or multiple thin films and may comprise, such as, for example broad or narrow band filters, comprising dyes, reflective notch films, such as, for example rugate thin films, diffraction gratings, as known in the art. Typical antireflective coatings may consist of alternating high (2.0-2.5) and low (1.38-1.46) refractive index layers of dielectric materials. Typical high index materials include Ta₂O₅, TiO₂, Nb₂O₅, ZrO₂ and SiN, and low index materials mainly SiO₂ and MgF₂. The coatings may be deposited to provide layers of quarter-wave (QW) thickness. The broader the band covered, generally the more layers are required in the coating applied to the surface.

The display may be selected from any output means such as, for example CRT, LCD, LED, OLED, projection, laser, liquid crystal on silicon (LCOS) device, such LCOS devices being illuminated by narrowband red, green and blue LED sources.

In a preferred arrangement the anti reflective coating on S₁ and S₂ may be selected such that only a narrow bandwidth of the red light, such as, for example, the red LED from a LCOS device may be partially reflected by the surface coating on S₂, so as to provide red warning or danger system information, to the user, as the secondary virtual image which appears in the foreground of the primary virtual image. Preferably the antireflective coating on surface S₁ can selectively not permit reflectance of only said narrow bandwidth, and so may allow other wavelengths of red light to be partially reflected, so as to permit a primary virtual image with a visually acceptable RGB colour output to the user, rather than the prior art typical monochrome colour output.

The display may provide an output from at least one system information, such as for example the vehicles original on board display panel (i.e. dashboard), an OEM or add-on entertainment system, navigation system or communication system. It may be desirable as a retro fit option, to provide a virtual image of the existing vehicle dashboard by using a video camera to capture real time output from the vehicle dashboard and so provide an image on the display panel, and hence to provide a virtual image via the partially reflective combiner. It may be desirable to provide further information from an external source i.e. traffic information or system information from at least two system information sources, the system information may then be overlaid or provided as two discrete messages, typically a warning secondary virtual image.

An embodiment of the invention will now be described by way of example only and with reference to the accompanying drawings of which:—

FIG. 1 shows a head up display schematic for a vehicle

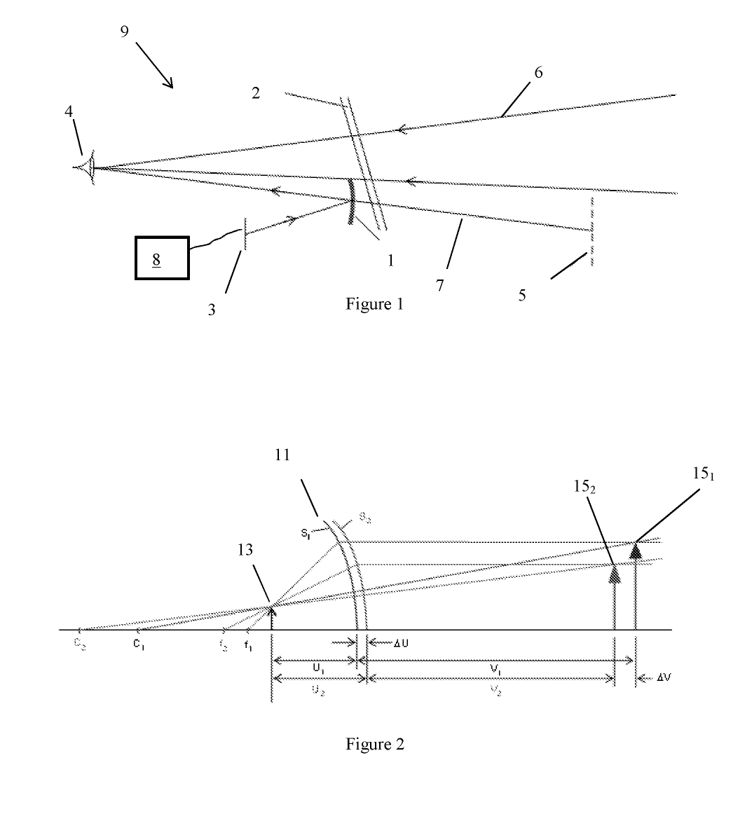

FIG. 2 shows a ray diagram for a partially reflective combiner

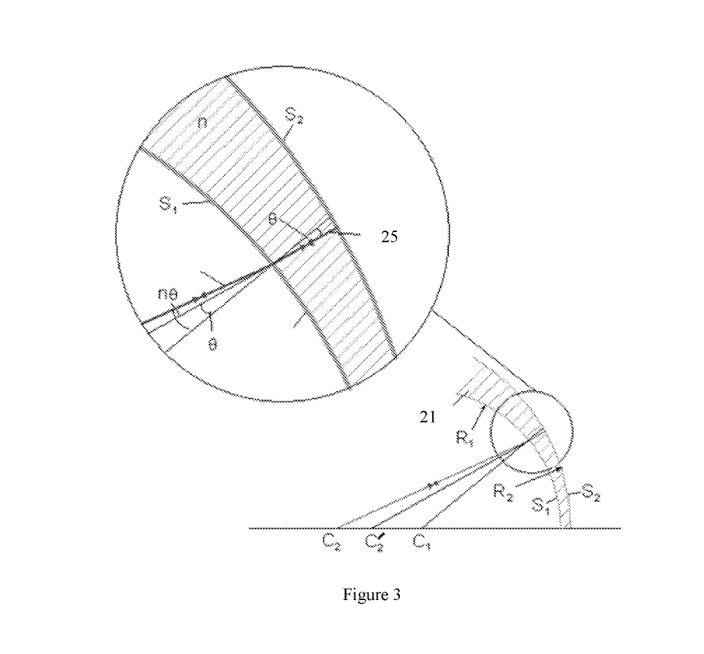

FIG. 3 shows a ray diagram for a partially reflective combiner

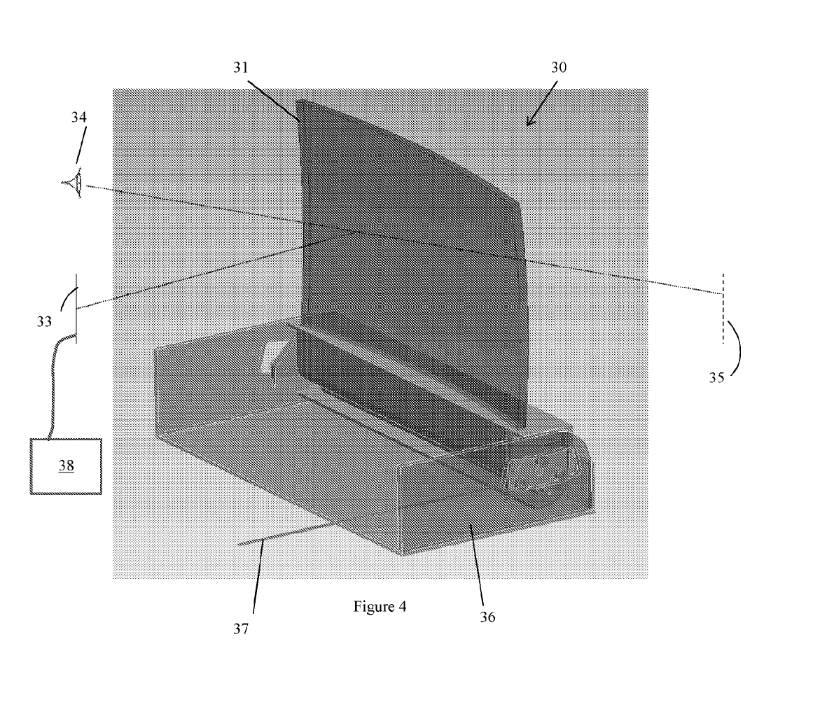

FIG. 4 shows a head up display device in a deployment device

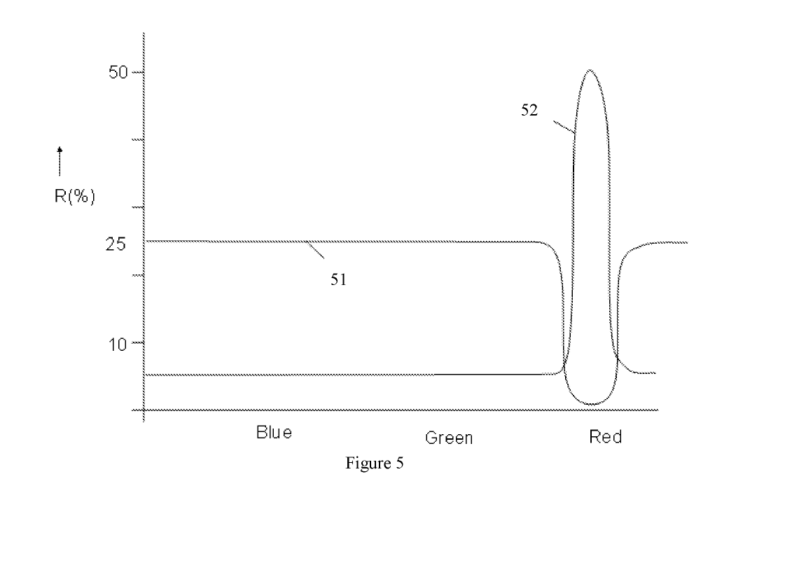

FIG. 5 shows a graph of spectral output from surface coatings providing monochrome selection.

Turning to FIG. 1, there is provided a display device 9, comprising a display 3, which provides a virtual image to be displayed in the line of sight 7, of the user 4. The display 3 outputs visual data from the vehicle information system 8, such as, for example, a car dashboard, satellite navigation, or an entertainment system.

The display 3 projects the image to a partially reflective combiner 1, which provides a virtual image 5, remote from the user 4, outside of the vehicle windscreen 2. The use of a combiner 1, removes the requirement of using the vehicle windscreen 2 as the partially reflective surface, and thus allows the display device 9 to be readily retrofitted to any vehicle, without prior consideration of the optical properties of the vehicle windscreen.

FIG. 2 provides a ray diagram indicating the path from the object 13(nominally the display), through the combiner 11. The combiner 11, has a first surface S₁ and a second surface S₂, The radius of the first and second surfaces are different and are selected such that S₁ provides a first virtual image 15₁ as the primary virtual image. Light impacting on the second surface S₂ provides a secondary virtual image 15₂, which lies in front of the primary virtual image, with respect to the user (not shown).

FIG. 3 provides a cross section of the lens 21. When the volume between S₁ and S₂ is filled with a material of refractive index n, a negative meniscus lens is formed which tends to increase the effective radius of curvature of surface S₂. Therefore the value of R₂ has to be decreased to compensate. By ray tracing, the required new value, R′₂, centre of curvature, C′₂, 25, is given by: (from the imaging formula for a concave mirror provided above)

$${R}_{2}^{′} = {R}_{2} - ( \frac{n - 1}{ n} ) ( {R}_{2} - {R}_{1} )$$

In one experiment the following lens dimension was prepared where the respective radii was determined by:

### M=6.6

### U=212 mm

### ΔU=4 mm

n=1.52 (BK7 glass)
and the desired separation between the primary and secondary virtual images (ΔV)=500 mm, to provide a warning secondary virtual image.
From this, R₁ can be calculated from

$$\begin{matrix}{R}_{1} = \frac{2 MU}{( M - 1 )} \\ = 500 mm\end{matrix}$$

### and V=MU=1400 mm

It can be shown that R′₂ is given:

$${R}_{2}^{′} = {R}_{2} - ( \frac{n - 1}{ n} ) ( {R}_{2} - {R}_{1} )$$

where

$${R}_{2} = \frac{2 ( U + Δ U ) ( MU - Δ V )}{U ( M - 1 ) - ( Δ V + Δ U )}$$

R₂=569 mm

### and R′₂=545 mm

In FIG. 4 there is provided a HUD system 30 comprising a combiner 31 in a deployment housing 36. The combiner may be deployed to the active position as shown when in use, such that the user 34, is able to view a virtual image 35, which is caused by the display 33, projecting a virtual image of the data from the vehicle information system 38. A draw cord 37 may be activated by a servomotor, to provide raise and lower the combiner 31. In the inactive position the combiner lies in a position which is substantially orthogonal to that shown in FIG. 4.

FIG. 5 shows a graph of wavelength vs reflectance, for a preferred arrangement of antireflection coatings, wherein the first coating 51 on surface S₁, provides a good “average” reflectance of two broad colour wavebands, in this instance specifically blue and green, but does not allow a narrow band of red light to progress through to the primary virtual image. The first coating 51, will preferably have a very narrow band of non-reflected light, so as to ensure that some degree of red light can be used in the primary virtual image.

The second coating 52, is applied to the surface S₂, the coating has maximum reflectance characteristics in the same narrow wave band, and minimal reflectance in all other visible wavelengths, nominally red in this instance, so as to allow only this narrow band of red light to be projected as the secondary virtual image. Hence when the display emits an image in this narrow waveband red region, the first coating 51 does not reflect this colour image so it does not appear in the primary virtual image. However, the second coating 52, allows this narrow band of red light to be reflected and hence produce the secondary virtual image (as shown in FIG. 2—15₂), that appears closer to the user. Therefore a warning or danger sign may be projected by the display in the narrow waveband red region, such that the warning secondary virtual image shows the warning information as a red secondary virtual image in front of the primary virtual image.

Clearly, the antireflection coatings may be selected to allow which ever narrow waveband of colour, to be projected as the secondary virtual image. Red has been selected merely as an example of a colour typically associated with hazards.

1. A display device for vehicles comprising:
a display which provides system information that is to be displayed to a user; and
a partially reflecting combiner, which magnifies the system information from the display, and provides a virtual image of said display;
wherein said partially reflecting combiner has a first curved surface S₁ and a second curved surface S₂, the first curved surface S₁ being closer to the display than the second curved surface S₂, wherein the radii of curvature of surface S₂>S₁, so as to provide two non-coincident virtual images.

2. A display device according to claim 1 wherein the partially reflecting combiner is a negative meniscus lens.

3. A display device according to claim 1, wherein the radius of curvature, R₂, of surface S₂ is adjusted to generate a secondary virtual image that appears in front of a primary virtual image generated by surface S₁.

4. A display device according to claim 1 wherein the volume between S₁ and S₂ is filled with a material of refractive index n, wherein the effective curvature of R′₂ is given by
$${R}_{2}^{′} = {R}_{2} - ( \frac{n - 1}{ n} ) ( {R}_{2} - {R}_{1} ) .$$

5. A display device according to claim 1 wherein at least one anti-reflection coating is applied to at least one of surfaces S₁ or S₂.

6. A display device according to claim 5 wherein there is at least one anti-reflection coating on surface S₁ and at least one anti-reflection coating on surface S₂.

7. A display device according to claim 6, wherein the anti-reflection coating on S₁ is selected, such that S₁ has a reflectance minima in a first narrow wave band.

8. A display device according to claim 7 wherein the anti-reflection coating on S₂ is selected to have a reflectance maxima in substantially the first narrow wave band, such that a secondary virtual image projected from surface S₂ is presented in front of a primary virtual image from the surface S₁.

9. A display device according to claim 7 wherein the first narrow wave band, is selected to provide a warning secondary virtual image, to provide a warning or danger information in front of a primary virtual image from the surface S₁.

10. A display device according to claim 1 wherein the two non-coincident virtual images include a secondary virtual image and a primary virtual image that are separated by a distance in the range of from 200 mm to 600 mm.

11. A display device according to claim 1 wherein the display is a liquid crystal on silicon (LCOS) device, illuminated by narrowband red, green and blue LED sources.

12. A display device according to claim 11, wherein there is at least one anti-reflection coating on surface S₁ and at least one anti-reflection coating on surface S₂ and wherein the anti-reflection coatings on S₁ and S₂ are selected such that only the narrowband red LED from the LCOS device is reflected by the surface coating on S₂, so as to provide red warning or danger information to the user.

13. A display device according to claim 1 wherein the curvature of surface S₂>S₁.

14. A display device comprising:
a display which provides information that is to be displayed to a user; and
a partially reflecting combiner configured to magnify the system information from the display, said partially reflecting combiner having a first curved surface S1 and a second curved surface S2, the first curved surface S1 being closer to the display than the second curved surface S2, wherein the radii of curvature of surface S2>S1, so as to provide two non-coincident virtual images, the images including a primary virtual image and a secondary virtual image.

15. A display device according to claim 14, wherein the radius of curvature, R₂, of surface S₂ is adjusted to generate the secondary virtual image that appears in front of the primary virtual image generated by surface S₁.

16. A display device according to claim 15 wherein there is at least one anti-reflection coating on surface S₁ and at least one anti-reflection coating on surface S₂.

17. A display device according to claim 16, wherein the anti-reflection coating on S₁ is selected, such that S₁ has a reflectance minima in a first narrow wave band.

18. A display device according to claim 17 wherein the anti-reflection coating on S₂ is selected to have a reflectance maxima in substantially the first narrow wave band, such that the secondary virtual image projected from surface S₂ is presented in front of the primary virtual image from the surface S₁.

19. A display device according to claim 17 wherein the first narrow wave band is selected to provide the secondary virtual image, so as to provide a warning or danger information in front of the primary virtual image from the surface S₁.

20. A display device according to claim 1 wherein the display is a liquid crystal on silicon (LCOS) device, illuminated by red, green and blue LED sources, and wherein there is at least one anti-reflection coating on surface S₁ and at least one anti-reflection coating on surface S₂, and wherein the anti-reflection coatings on S₁ and S₂ are selected such that only the red LED from the LCOS device is reflected by the surface coating on S₂, so as to provide red warning or danger information to the user.
